(19) United States
(12) Patent Application Publication
(10) Pub. No.: US 2006/0131509 A1
(43) Pub. Date: Jun. 22, 2006

(54) Radiation detector, in particular for x- or gamma radiation, and method for producing it

(76) Inventors: Richard Matz, Bruckmuehl (DE); Wolfgang Rossner, Holzkirchen (DE)

Correspondence Address: HARNESS, DICKEY & PIERCE, P.L.C., P.O.BOX 8910, RESTON, VA, 20195, US

(21) Appl. No.: 11/304,690

(22) Filed: Dec. 16, 2005

(30) Foreign Application Priority Data
Dec. 17, 2004 (DE) 10 2004 060 932.2

(51) Int. Cl. G01T 1/24

(52) U.S. Cl. 250/370.11

(57) ABSTRACT

A radiation detector is disclosed, in particular an x-ray or gamma detector, having a number of photodetector elements that are arranged next to one another and establish a detection surface. A converter layer is further included, above the detection surface, that converts incident radiation of a first wavelength region into radiation of a second wavelength region. The photodetector elements are sensitive to radiation of the second wavelength region. The converter layer is designed as an at least two-dimensional photonic crystal that has a bandgap or at least a reduced transmission in all directions parallel to the detection surface for the radiation of the second wavelength region. The detector may reduce or even prevent crosstalk between individual channels without the need for dividing septa in the converter layer.

The present application hereby claims priority under 35 U.S.C. §119 on German patent application number DE 10 2004 060 932.2 filed Dec. 17, 2004, the entire contents of which is hereby incorporated herein by reference.

### FIELD

The present invention generally relates to a radiation detector having a number of photodetector elements that are arranged next to one another and establish a detection surface. The detector may include, for example, a converter layer lying thereabove that converts incident radiation of a first wavelength region into radiation of a second wavelength region, the photodetector elements being sensitive to radiation of the second wavelength region. The invention also generally relates to a method for producing such a radiation detector.

### BACKGROUND

Radiation detectors that are constructed from a number of juxtaposed photodetector elements and a converter layer lying thereabove and made from a scintillator material with high x-ray absorption are used, above all, for the spatially resolved detection of x-radiation or gamma radiation in dose-sensitive applications, for example in medicine. The x-radiation is absorbed in this converter layer and triggers optical luminescent radiation that is detected by the photodetector elements. Conventional photodiodes can be used as photodetector elements for detecting the x-radiation owing to this conversion of the incident x-radiation into optical radiation.

In typical fields of use of radiography methods such as, for example, x-ray inspection or medical x-ray diagnostics, the resolution achievable in the case of fluoroscopy plays an important role. A good resolution is achieved in the case of the use of detector arrays with closely juxtaposed small-area detector elements in conjunction with scattered radiation streams for delimiting the solid angle of the incident x-radiation. The isotropic emission of the luminescent light in the converter layer leads, however, to radiation losses and to crosstalk in neighboring detector channels which is not tolerable for the purpose of achieving adequate spatial resolution.

In order to avoid this crosstalk, scintillator layers are generally separated from one another by trenches, so-called dividing septa, which ideally run via the interspaces between the photodetector elements. Such a construction of an x-radiation detector is illustrated schematically in FIG. 1.

FIG. 1 shows in a sectional illustration the arrangement of the silicon photodiodes 1 in a silicon substrate 2 as well as the scintillator layer 3 lying thereabove. The individual photodiodes 1, together with the volume fraction, respectively lying thereabove, of the converter layer, form the pixels of the radiation detector. The dividing septa 4 in the scintillator layer 3 lie above the interspaces between the photodiodes 1. In this way, it is impossible for a visible light quantum 6 triggered in the scintillator layer 3 from a pixel by an x-ray quantum 5 to cause crosstalk with neighboring channels or pixels, since it is retroreflected at the dividing septa 4 into the pixel in which it was triggered. These dividing septa 4 are generally produced in the scintillator layer 3 by a sawing process. The saw notches are additionally filled with titanium oxide in order to increase the reflection at the boundaries of the respective pixel.

However, separating the scintillator layer by sawing is a time-consuming and costly process step. Moreover, owing to the mechanical subdivision of the converter layer the thickness of the converter layer is restricted for reasons of mechanical stability, and so the quantum absorption, and therefore the quantum efficiency, of this layer is also restricted.

### SUMMARY

An object of at least one embodiment of the present invention resides in specifying a radiation detector having a number of juxtaposed photodetector elements and a converter layer lying thereabove, and/or a method for producing it. Such a detector, in at least one embodiment, can be produced cost-effectively and/or enables a high quantum efficiency of the converter layer.

An object of at least one embodiment may be achieved with the aid of a radiation detector, and/or with a method.

In a known way, the present radiation detector of at least one embodiment, has a number of photodetector elements, for example photodiodes, that are arranged next to one another and establish a detection surface, and a converter layer lying above the detection surface that converts incident radiation of a first wavelength region (primary radiation) into radiation of a second wavelength region (secondary radiation). The photodetector elements are sensitive to radiation of the second wavelength region. In the case of the present radiation detector of at least one embodiment, the converter layer may be designed as an at least two-dimensional photonic crystal that has a transmission, reduced by comparison with other directions, in all directions parallel to the detection surface for the radiation of the second wavelength region.

Here, the converter layer of at least one embodiment may include an x-ray conversion phosphor or scintillator that converts incident x-radiation into optical radiation, in particular in the infrared or visible wavelength region.

In the case of the radiation detector of at least one embodiment, the converter layer may be designed as a two- or three-dimensional photonic crystal that, for propagation directions parallel to the detection surface but not perpendicular thereto, has a photonic bandgap or at least a substantially reduced transmission for radiation of the second wavelength region. As a rule, in this case the detection surface also lies parallel to the layer plane or surface of the converter layer. Photonic crystals have a periodic arrangement of materials of different refractive index. The differences in refractive index, and the periodicity, can be selected in such a way that, by analogy with electric semiconductors, the photonic crystal has for light of a specific wavelength region and one or more propagation directions a photonic bandgap such that the radiation cannot propagate in these directions.

The present converter layer may be constructed from such a crystal, also denoted below as PBG (PBG: Photonic Bandgap) material that suppresses, or at least substantially reduces, the propagation of the radiation of the second wavelength region in two dimensions, that is to say in all the material planes parallel to the detection surface.

At least one embodiment of the present invention is explained in more detail in the following sections with the aid of an x-radiation detector in the case of which x-radiation is converted in the converter layer into luminescent light. Of course, the present radiation detector can also be used to detect radiation in other wavelength regions by a suitable selection of the converter layer and the photodetector elements. Gamma radiation, which can be converted in the same way as x-radiation in luminescent light with the aid of a scintillator material, can be involved here, for example.

Furthermore, it is also possible to convert optical radiation of one wavelength region into optical radiation of another wavelength region, in particular if the photodetector elements used have better properties in the other wavelength region. Furthermore, it is not, of course, necessary for the secondary radiation to constitute luminescent radiation. Rather, the process of conversion of the radiation can also be caused by other physical processes.

In the ideal case, the converter layer is designed such that it has a complete two-dimensional bandgap for the luminescent light generated by the x-radiation. The luminescent light generated in the volume of the converter layer by absorption of x-ray quanta can then propagate unhindered only in a direction perpendicular to the detection surface. In the case of the luminescent wavelength of the converter layer, there is present in the directions parallel to the detection surface an optical bandgap that prevents the propagation of the luminescent light in these directions.

The PBG material of the converter layer preferably has a cubically face-centered arrangement (opal structure, diamond structure) of a material, denoted below as second phase, that is not x-ray luminescent and not optically absorbing, the interspaces being filled up by an x-ray luminescent material. The material of the second phase is preferably a gas, in particular air. The structure size, that is to say the distance after which the two materials are respectively periodically repeated, essentially follows the design rule of classic antireflection layers:
λ=2*n*D*f,
λ corresponding to the wavelength of the radiation to be suppressed, n to the effective refractive index of the composite material, and D to the extent of the periodically repeating elementary cell. The factor f is a correction factor of the order of magnitude of 1 that varies as a function of the respectively present three-dimensional arrangement of the two types of material.

For known scintillator materials for x-radiation that can be used in the present radiation detector such as, for example, Gd₂O₂S:Pr, CsI:Tl, (Y, Gd)₂O₃:Eu, CdWO₄ or LaCl:Ce, the refractive index n is between 2 and 4, and the emission wavelength of the luminescence is between 370 nm and 780 nm. Consequently, the structure sizes D of the second phase vary between 50 nm and 200 nm. It is not possible to generate a complete optical bandgap in all cases (transmission=0). However, for the present application, a partial limitation of the transmission in the wavelength region of the luminescence generated suffices for the substantial reduction of the envisaged crosstalk.

It is possible to dispense with subdividing the converter layer by trenches or dividing septa owing to the formation of the converter layer in the present radiation detector of at least one embodiment from a PBG material having the properties already set forth. Furthermore, the uniaxial light propagation without the need for vertical trenches renders it possible to design the converter layer to be substantially thicker than previously, thus enabling a higher quantum absorption, and thus higher quantum efficiency, without reducing the spatial resolution of the radiation detector. The result of this is to decouple from one another the two design parameters of quantum efficiency and point image function, which are usually contrary and necessitate compromise.

In an advantageous development of the radiation detector, the latter has an additional reflective layer for the secondary radiation on the converter layer. Secondary radiation, which propagates in the opposite direction to the incident x-radiation, is retroreflected by this reflective layer in the direction of the photodetector elements. This reflective layer therefore leads to a further reduction in radiation losses.

A photonic crystal is a body that is constructed from at least two materials. It arises owing to a crystal lattice structure from a first material that has a periodicity in the region of the light wavelength. The periodic cavities in the crystal lattice structure of this first material are filled with a second material, for example air. An important precondition for the functioning of a photonic crystal or PBG material is a clear difference in refractive index between the two materials used. Photonic crystals are subdivided according to direction of the modulation into one-dimensional, two-dimensional and three-dimensional photonic crystals.

A one-dimensional photonic crystal has a modulation of the refractive index only in one direction. Two-dimensional photonic crystals exhibit the modulation in two spatial directions, while three-dimensional photonic crystals do so in all three spatial directions. Two-dimensional photonic crystals can be formed, for example, by periodically arranged, cylindrical pores in a material of high refractive index. The second material, which constructs the photonic crystal, is air, for example. The pores can be etched into the material, proceeding from a starting point.

The converter layer is preferably designed as a two-dimensional photonic crystal for the present radiation detector of at least one embodiment. Computing methods such as are known from the field of photonic crystals for microwave applications can be used for dimensioning. This holds equally for the production of the converter layer, for which it is likewise possible to use production techniques such as are known, for example, from E. Yablonovitch, “Photonic Bandgap Based Designs for Nano-Photonic Integrated Circuits”, International Electron Devices Meeting, Technical Digest IEEE: Piscataway, USA, 2002, pages 17-20, or from S. Kirihara et al., “Control of Microwave Emission from Electromagnetic Crystals by Lattice Modifications”, Solid State Communications 124 (2002), pages 135-139, the entire contents of each of which is hereby incorporated herein by reference. In the event of designing the converter layer as a three-dimensional photonic crystal, it must be ensured by suitable selection of the crystal parameters that the crystal has no bandgap for the secondary radiation in the third dimension, that is to say perpendicular to the detection surface.

In the case of at least one embodiment of the present method for producing the radiation detector, a substrate having a number of photodetector elements that are arranged next to one another and establish a detection surface is provided. This substrate with the photodetector elements can be produced by means of customary methods in semiconductor technology, in particular silicon technology. Applied to the substrate with the photodetector elements is a converter layer that converts incident radiation of a first wavelength region into radiation of a second wavelength region.

In the case of at least one embodiment of the present method, the converter layer may be produced as an at least two-dimensional photonic crystal that has a photonic bandgap, or at least reduced transmission in all directions parallel to the detection surface, for the radiation of the second wavelength region. The production of the converter layer can be performed with the aid of different techniques of which a few are set forth, for example, in the subsequent example embodiments.

### BRIEF DESCRIPTION OF THE DRAWINGS

The present radiation detector of at least one embodiment and example methods of at least one embodiment for producing the converter layer of such a detector are explained once again by way of example in the following example embodiments without limiting the scope of protection prescribed in the patent claims in conjunction with the drawings, in which:

FIG. 1 shows a schematic of an example of the design of a radiation detector in accordance with the prior art;

FIG. 2 shows a schematic of an example of the design of a radiation detector in accordance with at least one embodiment of the present invention;

FIG. 3 shows an example of an arrangement of fibers in the production of the converter layer of at least one embodiment of the present radiation detector; and

FIG. 4 shows a very schematic further example of the production of the converter layer of at least one embodiment of the present radiation detector.

### DETAILED DESCRIPTION OF THE EXAMPLE EMBODIMENTS

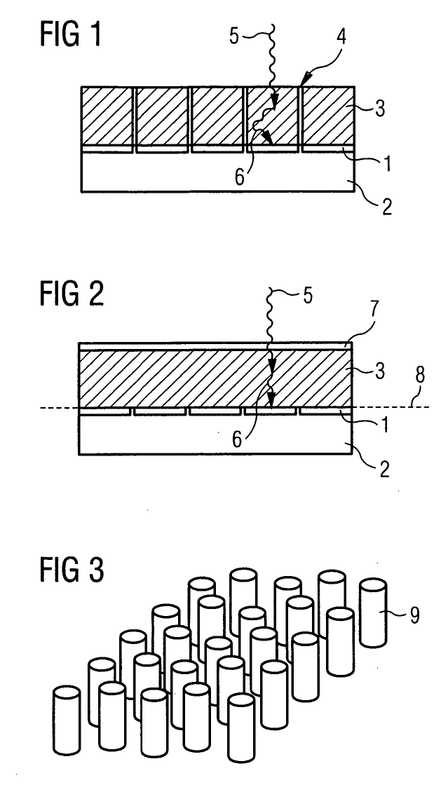

The known design of a radiation detector in accordance with the prior art has already been explained in conjunction with FIG. 1 in the introduction to the description. The production of the dividing septa 4 for subdividing the scintillator layer 3 into individual pixels is a process step that is time-consuming and costly.

As is illustrated sectionally in FIG. 2, this step of separating the scintillator layer 3 can be dispensed with in the case of the present radiation detector of at least one embodiment. In this example, the present radiation detector of at least one embodiment similarly has a silicon substrate 2 in which silicon photodiodes 1 are arranged in rows and columns in order to form a detector array. The silicon photodiodes 1 thereby establish a detection surface 8 that is indicated in the figure. Lying on these photodiodes 1 or the detection surface 8 is a converter layer 3 that is designed as a two-dimensional photonic crystal and therefore has a two-dimensional PBG structure.

A propagation of the luminescent radiation, triggered by incident x-radiation, in all directions parallel to the detection surface 8 is suppressed by this structure with periodically varying refractive index in the layer plane, that is to say parallel to the detection surface 8. However, the luminescent radiation can propagate virtually unhindered perpendicular to the detection surface 8, and therefore strike the photodiodes 1.

FIG. 2 shows by way of example for this purpose the irradiation of an x-ray quantum 5 that generates a visible light quantum 6 in the converter layer 3. Owing to the photonic bandgap of the converter material, this visible light quantum 6 can propagate only in the direction of the photodiode 1 lying therebelow, or in the opposite direction. Crosstalk in neighboring channels may thus be reduced or even prevented in this way solely on the basis of the internal structure of the converter layer.

In the present example embodiment, there is additionally applied to the surface of the converter layer 3 a thin metal layer 7 that serves as mirror for retroreflection of luminescent radiation emerging approximately perpendicular to the surface. The material of the metal layer, for example Al, is selected in this case such that the incident x-radiation can pass without hindrance.

Different techniques can be used to produce the converter layer 3 on the present radiation detector. The elementary cell of the photonic lattice of the converter layer has dimensions corresponding to the light wavelength of the luminescent radiation, for example in the region of 500 nm. Four examples are shown below for the production of such a converter layer.

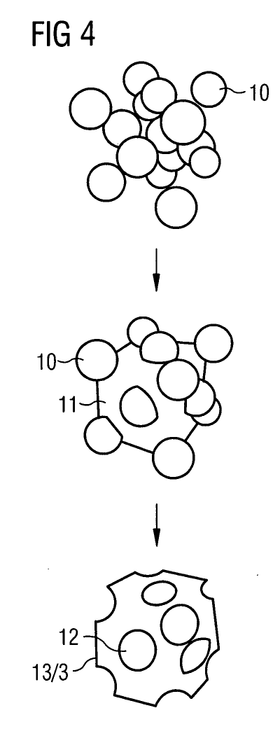

In a first example, which is illustrated in FIG. 4 in a very schematic fashion, a cubically face-centered structure composed of polymer balls 10, for example polystyrene, of suitable size, for example between 200 and 400 nm, is constructed by self-organization. This can be performed, for example, via a colloidal solution of these balls. The separation from the solution uses the principle of self-organization.

Owing to the driving force of the minimization of the free energy of the system, in the case of slow deposition balls in a suspension preferably form a cubically face-centered or hexagonally close packing. The deposition of the balls is performed either by sedimentation, evaporation of the solvent of the suspension, or by electrophoretic separation. After the production of the cubically face-centered layer structure, the cavaties are filled with a fine-particle, if appropriate nanoscale, ceramic x-ray fluorescent material 11 that preferably also includes a binder.

Subsequently, the layer produced or the body produced is compressed, for example by pressing, or strained in one direction (perpendicular to the surface of the converter layer which is to be produced) such that the structural parameters in this direction are insufficient for a bandgap in the wavelength region of the luminescent light of the x-ray fluorescent material used. This preliminary body is then treated in a thermal step (approximately up to 600° C.) such that the organic fractions, in particular the polymer balls, are removed pyrolytically and leave cavities 12 behind.

In a subsequent second thermal step, the ceramic skeleton structure is then sintered to form a solid body with regularly arranged cavities 12. This gives rise to the desired modulation of the refractive index between the ceramic skeleton 13 composed of the x-ray fluorescent material and the cavities 12 filled with air, which produces the desired bandgap in the desired directions in the layer plane. Such layers can be up to 2 mm thick.

In a second example, the converter layer can be produced by constructing a so-called woodpile structure as is known from the prior art relating to photonic crystals. During the production of such a structure for the present converter layer, a stacked rod structure is constructed with the aid of thin film techniques such that scintillator material and inert material, that is to say material that is not x-ray luminescent and optically transparent, are detached systematically in the required PBG dimensions. A three-dimensional photonic crystal is first of all produced in this way. The spatial direction in which no bandgap is to be present for the luminescent wavelength(s) can be implemented by simple changes to materials or dimensions. In the case of the production technique, as well, organic components can be removed pyrolytically or a sintering process can be included, depending on the materials used.

In a third example, a structure that resembles the so-called Yablonovitch structure is built up. This structure is set forth in the abovementioned publication by A. Yablonovitch. Instead of the bores present in this structure, in the case of the present method fibers 0.2-0.3 μm thick are firstly interwoven to form a three-dimensional diamond structure. The required luminescence can be achieved by doping the fibers themselves, by coating the fibers, for example with ceramic, or by introducing luminescent material into the fabric interspaces. The composite material can then be uniaxially shaped by pressing or pulling in order to form a preferred direction for the propagation of light. In a refinement of this variant, the fibers can also consist of organic material, and the luminescing medium of green ceramic. When this composite is burned, the organic constituents are then burnt out and the ceramic frame remains intact.

In a fourth example embodiment, similar fibers 9 are used; however, they are not interwoven but bundled in parallel to form a two-dimensional hexagonal grid as indicated in FIG. 3. Here, as well, the required luminescence can be achieved by doping the fibers themselves, by coating the fibers, for example with ceramic, or by introducing luminescent material into the fabric interspaces. Interweaving the fibers can be omitted in this case since the hexagonal arrangement arises from self-organization. The fiber bundle is finally sawed into disks perpendicular to the fiber axes such that the fibers 9 in the converter layer 3 are at right angles to the detection surface 8. In a further variant, instead of long fibers use can already be made of short fiber pieces or doped nanotubes such that sawing the fiber disks can be eliminated.

Of course, the abovenamed examples of the production of the converter layer are not to be understood as an exhaustive enumeration. Rather, the converter layer can also be produced using other methods, with the aid of which the required photonic crystal structure of the layer can be generated.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A radiation detector comprising:
a plurality of photodetector elements, arranged next to one another to establish a detection surface; and
a converter layer, above the detection surface, that converts incident radiation of a first wavelength region into radiation of a second wavelength region, the photodetector elements being sensitive to radiation of the second wavelength region, and the converter layer being designed as an at least two-dimensional photonic crystal having an at least reduced transmission in all directions parallel to the detection surface for the radiation of the second wavelength region.

2. The radiation detector as claimed in claim 1, wherein the converter layer includes a photonic bandgap in all directions parallel to the detection surface for the radiation of the second wavelength region.

3. The radiation detector as claimed in claim 1, wherein the converter layer consists of a first material which converts the incident radiation of the first wavelength region into radiation of the second wavelength region, and a second material, which is transparent to radiation of the second wavelength region.

4. The radiation detector as claimed in claim 3, wherein the second material is present in a cubically face-centered arrangement in the converter layer.

5. The radiation detector as claimed in claim 3, wherein the second material is a gas.

6. The radiation detector as claimed in claim 1, wherein a reflective layer is applied to the converter layer for retroreflecting emerging radiation of the second wavelength region into the converter layer.

7. The radiation detector as claimed in claim 1, wherein the converter layer includes an x-ray conversion phosphor or a scintillator material.

8. The radiation detector as claimed in claim 1, wherein the converter layer converts at least one of x-radiation and gamma radiation into optical radiation.

9. The radiation detector as claimed in claim 1, wherein the photodetector elements are photodiodes.

10. The radiation detector as claimed in claim 1, wherein the photodetector elements are arranged next to one another in rowwise and columnwise fashion.

11. A method for producing a radiation detector, comprising:
producing a substrate having a number of photodetector elements arranged next one another and establishing a detection surface; and
applying a converter layer, that converts incident radiation of a first wavelength region into radiation of a second wavelength region, to the photodetector elements, the converter layer being produced as an at least two-dimensional photonic crystal that has a photonic bandgap, or at least reduced transmission in all directions parallel to the detection surface, for the radiation of the second wavelength region.

12. The method as claimed in claim 11, wherein the converter layer is produced by constructing a photonic crystal structure made from an organic material, by filling up interspaces in the structure with a ceramic material converting the radiation of the first wavelength region into radiation of the second wavelength region, and by subsequent heat treatment in the case of which the organic material is burnt out and the ceramic material is sintered.

13. The method as claimed in claim 12, wherein at least one of fibers and balls of a polymer material are used for constructing the photonic crystal structure.

14. The method as claimed in claim 11, wherein the production of the converter layer is performed by constructing a photonic crystal structure made from at least one of fibers and nanotubes that are transparent to radiation of the second wavelength region and are doped or coated with a material converting the radiation of the first wavelength region into radiation of the second wavelength region.

15. The method as claimed in claim 11, wherein in order to produce the converter layer, a three-dimensional photonic crystal structure is firstly constructed which has a bandgap or at least reduced transmission for the radiation of the second wavelength region in all spatial directions, and the crystal structure is subsequently mechanically stretched or compressed in a spatial direction perpendicular to the detection surface in order to cancel the bandgap or reduced transmission in this spatial direction for the radiation of the second wavelength region.

16. The radiation detector as claimed in claim 1, wherein the converter layer includes a first material which converts the incident radiation of the first wavelength region into radiation of the second wavelength region, and a second material, which is transparent to radiation of the second wavelength region.

17. The radiation detector as claimed in claim 16, wherein the second material is present in a cubically face-centered arrangement in the converter layer.

18. The radiation detector as claimed in claim 4, wherein the second material is a gas.

19. The radiation detector as claimed in claim 5, wherein the second material is a gas.

20. The method as claimed in claim 11, wherein the converter layer is produced by constructing an at least approximately hexagonal or cubically face-centered structure made from an organic material, by filling up interspaces in the structure with a ceramic material converting the radiation of the first wavelength region into radiation of the second wavelength region, and by subsequent heat treatment in the case of which the organic material is burnt out and the ceramic material is sintered.

21. The method as claimed in claim 11, wherein the production of the converter layer is performed by constructing an at least approximately hexagonal or cubically face-centered structure, made from at least one of fibers and nanotubes that are transparent to radiation of the second wavelength region and are doped or coated with a material converting the radiation of the first wavelength region into radiation of the second wavelength region.
